(19) United States
(12) Patent Application Publication
(10) Pub. No.: US 2012/0293655 A1
(43) Pub. Date: Nov. 22, 2012

(54) Vertical Rod Engaging Latch Lock

(75) Inventors: Robert Loughlin, Stanton, NJ (US); John Loughlin, Lebanon, NJ (US)

(73) Assignee: Stanton Concepts, L.L.C., Stanton, NJ (US)

(21) Appl. No.: 13/474,012

(22) Filed: May 17, 2012

Related U.S. Application Data
(60) Provisional application No. 61/487,990, filed on May 19, 2011.

(51) Int. Cl. E05B 47/00; H04N 7/18; E05B 65/06; E05B 65/52; E05C 1/10; E05B 65/00

(52) U.S. Cl. 348/143; 292/145; 70/277; 348/E07.085

(57) ABSTRACT

A door is secured to a frame with a vertical rod engaging lock operated by a handle. The handle is secured inside a latch lock with a housing attached to the door and a moving part movable inside the housing, both having an opening enabled to receive the handle in a first position with the moving part inside the housing in a first position. The housing includes a first and second side slot. The moving part is enabled to be moved into the housing in a blocking position by the handle being moved into the first and second side slot causing the moving part to fill at least partially the opening in the housing to provide a secured handle.

### CROSS REFERENCE TO RELATED APPLICATIONS

The present application claims the benefit of and priority to U.S. Provisional Patent Application Ser. No. 61/487,990 filed on May 19, 2011, which is incorporated herein by reference in its entirety.

### BACKGROUND OF THE INVENTION

Aspects of the present invention relate to a lock or a latch of a swinging barn door style door as applied to a truck, trailer, or shipping container. More particularly, aspects of the present invention relate to a new embodiment of such a lock or latch and protection thereof.

The popular swinging doors found on trucks, trailers, and shipping containers use vertical rod engaging closure devices that include latch handles. The latch handles provide the rotation motion required to secure the top and bottom engagement of the vertical rods of the closed door. The closed latch handle is engaged with a receiver element attached to the closed door that includes the means to attach a separate generic padlock and/or tamper indicative seal to secure the system.

This system has been, for many years, appropriate and adequate. In applications that require frequent opening and closing of the doors the proper management of padlocks and seals may be neglected by the driver/operator. In addition the popular generic padlocks in use are vulnerable to simple forcing attack.

Accordingly, there is a need to enhance the protection and ease of use of the basic latch mechanism found on swinging doors. Novel and improved means and methods to provide better security for the vertical rod engaging latch system for swinging doors are required to assure proper closing and securing of the doors by the driver/operator.

### SUMMARY OF THE INVENTION

In accordance with an aspect of the present invention, a lock to secure a handle, the handle having a width and a thickness, is provided. The lock includes a housing that is at least partially hollowed with a top opening to receive a movable part that fits inside the housing, the housing including an angled opening across a front face enabled to receive the width of the handle in a first position, the housing including a first slot in a first side of the housing below the angled opening and a second slot in a second side of the housing below the angled opening, the first slot and the second slot enabled to receive the thickness of the handle. The movable part includes an angled opening across a front face enabled to receive the width of the handle in the first position when the movable part is inside the housing and the angled openings of the housing and the movable part are aligned. The housing covers at least partially the angled opening of the movable part and the movable part fills at least partially the angled opening of the housing when the handle is moved from the first position into a second position.

In accordance with an aspect of the present invention, the lock can include a locking mechanism that secures the movable part to the housing. The housing can be secured to a door. The door can be on a truck and the handle is part of a rod lock. The locking mechanism can be a keyed lock, an electronic lock, or a dual custody lock.

In accordance with another aspect of the present invention, the lick can include a mobile computing device connected to the lock to monitor a status of the lock.

The lock can replace an existing lock.

In accordance with a further aspect of the present invention, the latch lock includes a camera monitoring the lock to record an event related to the lock.

In accordance with another aspect of the present invention, a method of securing a door to a frame is provided. First, an opening in a fixed latch lock housing is aligned with an opening in a moving part located in the latch lock housing. Then, a handle is placed inside the aligned openings in the latch lock housing and the moving part. Then, the handle is moved inside the latch lock housing to a blocked position by moving the handle downward, wherein the moving part moves downward in the latch lock housing and moves through a slot in a side of the latch lock housing. This engages the handle in place within the latch lock housing.

The method, in accordance with a further aspect of the present invention, can include the step of locking the moving part within the latch lock housing with a locking device.

In accordance with a further aspect of the present invention, the method can include monitoring a status of the door with a mobile computing device.

### BRIEF DESCRIPTION OF DRAWINGS

FIG. 1 illustrates the back door of a truck or a trailer with barn or swing doors and a vertical rod engagement with a lockable latch.

FIGS. 2 and 3 illustrate the operation of a generic lockable latch.

FIG. 4 illustrates a lock in accordance with aspects of the present invention.

FIGS. 5A and 5B illustrate front and side views of a lock in accordance with aspects of the present invention.

FIG. 6 illustrates a cross sectional side view of the lock in accordance with aspects of the present invention.

FIG. 7 illustrates parts of the lock in accordance with an aspect of the present invention.

FIGS. 8 to 15 illustrate further aspects of the lock of the present invention.

FIGS. 16 to 19 illustrate a further embodiment of the present invention where a separate padlock is used.

FIG. 20 illustrates a further aspect of the present invention where a camera or sensor is used.

FIG. 21 illustrates a monitor in accordance with a further aspect of the present invention.

FIGS. 22 and 23 illustrate a particular embodiment of the present invention.

FIG. 24 illustrates operation of a lock in accordance with an aspect of the present invention.

### DETAILED DESCRIPTION

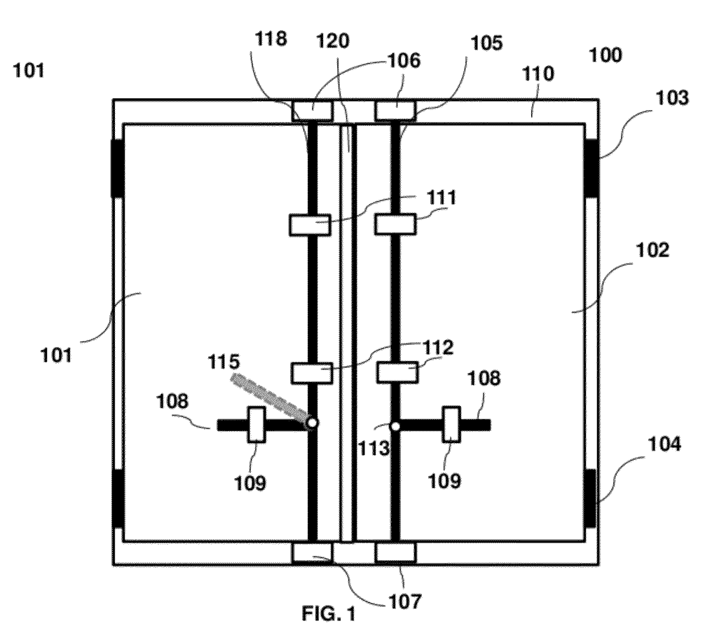

FIG. 1 illustrates in diagram a back 100 of a truck, or trailer, or shipping container with barn or swing doors 101 and 102 and vertical rods 105 with a lockable latch combination 108 and 109. Different configurations may exist and the diagram of FIG. 1 is included to provide context for one or more aspects of the present invention.

The rear 100 of the truck is symmetrical regarding the two doors 101 and 102. The elements of door 102 are further explained herein. The door 101 is identical (in mirror) to 102. Door 102 is hinged on hinges 103 and 104 to a frame 110 of the truck. Vertical rods 105 are movably fixed to the doors 101 and 102 by holding elements 111 and 112. Attached to the rods 105 is a handle 108 by a rotating mechanism with pin 113 allowing the handle 108 to be rotating in a plane determined by the handle and the rod. A user thus can move the rod 105 from an engaged into an unengaged position by moving handle 108 about the axis of vertical rod 105. The vertical rod 105 is rotated about its axis to release the engaging elements 106 and 107 to permit the door 102 to be opened by means of the hinges 103 and 104.

The handle 108 can be attached to door 102 and prevented from being rotated by latch element 109 which is attached to the door 102 and can be latched and locked, for instance by a padlock, thus preventing the door latch to unlatch and from being opened. The rod 105 of door 102 is shown in its engaged state. In that state the two ends of the rod are captured by engaging elements 106 and 107 which are attached to the frame 110 of the truck.

When the handle 108 is released from latch element 109 by the motion of movable hasp 201 the handle 108 may rotate around pin 113 and act as a lever to rotate the vertical engaging rod 105 around its axis. This rotation will disengage the rod engaging elements 106 and 107 and permit the door 100 to be rotated open about hinges 103 and 104.

In general, door 101 is locked when door 102 is locked. One may release the rod 118 from its capturing elements, but door 102, when locked, will keep door 101 in a closed position. For instance a flange like extension 120 of door 102 may cover door 101 in closed position. In such a situation only handle 108 has to be locked with a lock when doors 101 and 102 are closed to secure both doors.

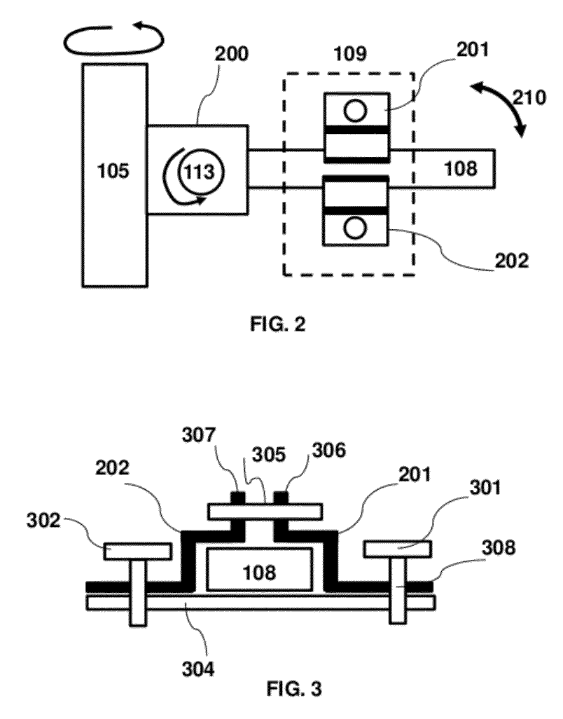

FIG. 2 illustrates in further detail how handle 108 is secured. The handle 108 has two different rotational motions. Handle 108 rotates around pin 113 within housing 200 as illustrated by arrow 210. Movable hasp 201 may move away and permit handle 108 to move out of fixed hasp 202 in a motion indicated by arrow 210. Handle 108 is then free to act as a lever to cause rod 105 to rotate about its axis and disengage engaging elements 106 and 107 of the top and bottom of door 102. The door 102 is then free to open on hinges 103 and 104.

To lock the handle 108, the hasp 201 is rotated away from handle 108 to allow the handle 108 to be placed within the hasp 202. The hasp 201 is then rotated to capture and hold the handle as shown in FIG. 3. The hasps 201 and 202 have flanges 306 and 307, respectively, each provided with a hole to receive a shackle 305. When the flanges are aligned, a shackle 305 of for instance a padlock can be placed through the holes in the flanges, thus locking the handle 108 inside brackets 201 and 202 against the door with latch element 109.

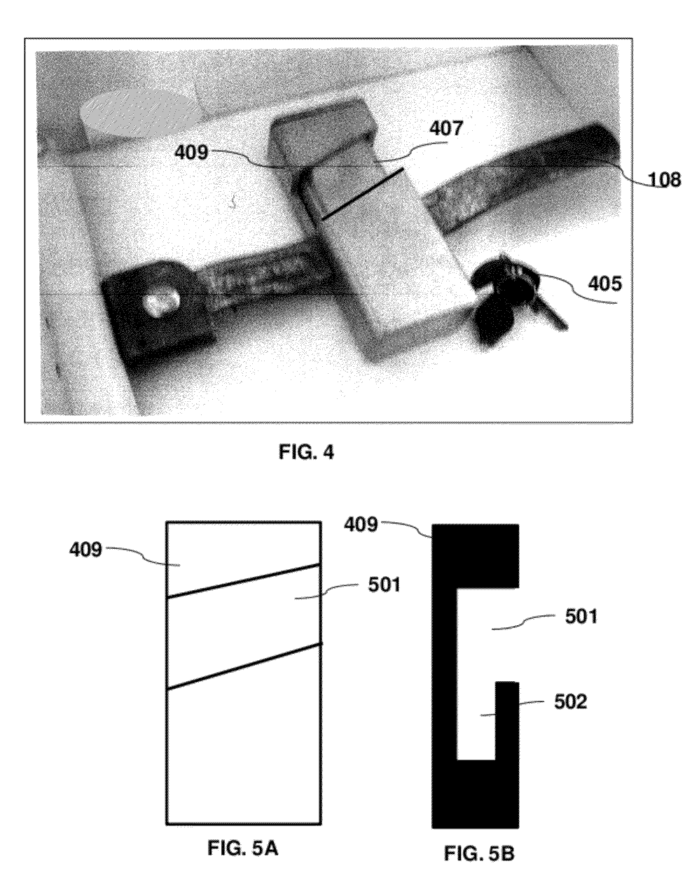

A novel latch lock, provided in accordance with an aspect of the present invention is illustrated in FIG. 4. It shows the novel latch lock housing with a fixed part 409 and a moving part 407, which receives the handle 108 and allows the handle to be rotated to engage with the capturing elements and rotates to secure the handle in slots 501/801 of 409 and 407. The fixed part of the latch lock may be called the fixed housing of the latch lock.

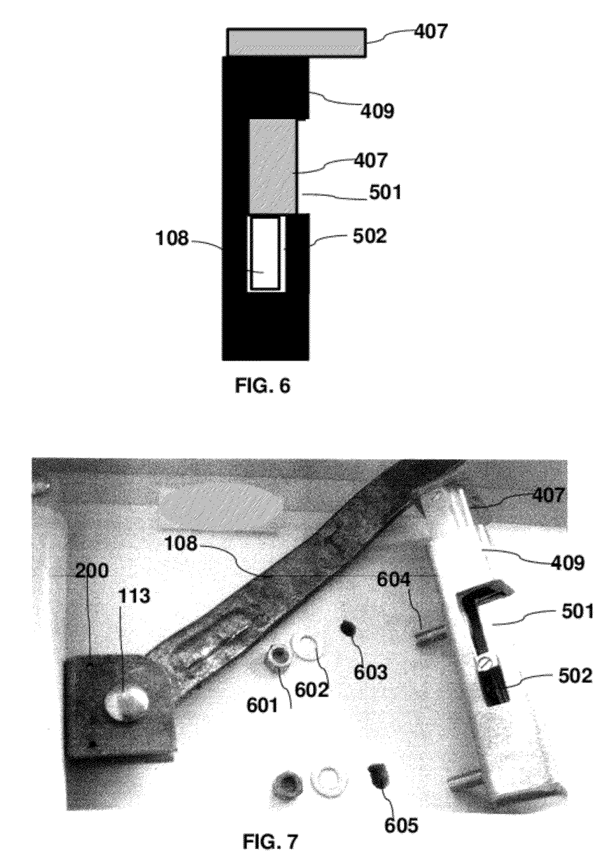

Once the handle 108 is received in the front opening 501 of fixed part 409 and as illustrated in FIGS. 5A and 5B and movable part 407 which may also be called a moving part 407 (and is illustrated in for instance FIG. 6) of the novel latch lock the handle 108 may be rotated about the pin 113 causing the moving part 407 to become fully engaged within the fixed part 409.

In one embodiment of the present invention, the movable part 407 is provided with a locking element that can be received and engaged by a lock inside and secured to fixed part 409. Such a lock can be locked and unlocked by a key, such as a key 405. Such a lock can also be locked and/or unlocked by an electrical or an electronic or an electromagnetic signal. The part 409 is fixed to the truck door and replaces 109 as shown in for instance FIG. 2 using preferably existing holes.

FIGS. 5A and 5B illustrate in diagram a frontal (FIG. 5A) and a side view (FIG. 5B) of latch lock fixed part 409 with a frontal opening 501 to receive the handle 108 when the rod 105 is rotated to engage with its capturing elements 106 and 107. The handle is rotated towards the door and positioned in front of opening 501 which is sufficient in size to receive the handle. The handle is pushed towards the door so the handle is received by opening 501. The handle is now in a positioned to be rotated downward into side slot 502 as illustrated in the side-view diagram in FIG. 5B. The fixed part 409 of the latch lock also has a corresponding side slot 503 at the opposing side of 502, which is not shown in FIGS. 5a and 5B but is identified in FIG. 20.

FIG. 6 illustrates in cross sectional side view the latch lock fixed part 409 with the handle 108 engaged in the side slot 502 and the movable part 407 being placed inside 409 and covering at least part of opening 501 so it prevents handle 108 from being disengaged from slot 502.

FIG. 7 illustrates the replacement parts of the known latch 109 with the new latch lock 409 as provided herein in accordance with an aspect of the present invention. It shows the handle 108 attached to a pin 113 in a housing 200 about which the handle can be rotated. Also shown are the holes 603 and 605 in the door through which the old latch 109 was attached to the door. The new latch lock element 409 is provided with two bolts or studs of which one (604) is identified. Bolt or stud 604 is placed through hole 603 and fixed to the door with washer 602 and nut 601.

Also identified is the movable part 407 which is partially placed inside 409, but not yet covering opening 501. The second bolt or stud is fastened through hole 605.

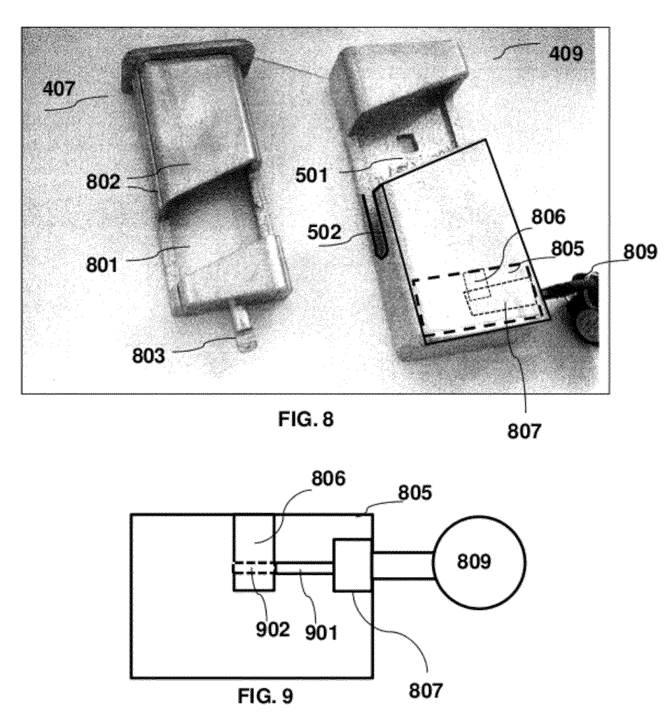

FIG. 8 illustrates the fixed part 409 and moving part 407 of the latch lock housing, which is attached to the door and will receive the handle 108 in the openings 501 and 801. The handle 108 when in a position corresponding with openings 501 and 801 in latch lock fixed part 409 on a door, corresponds in one embodiment of the present invention to a position of the rod 105 that is moved by the handle still in an open or unsecured position.

Further identified in fixed part 409 is the side slot 502. Also identified is a lock 805 inside 409. This part is generally not visible from the outside, so its diagram applies a dotted line.

The lock 805 is fixedly attached to the lock latch lock housing 409. It comprises a receiving element 806 and a locking mechanism 807 with a key 809. While the locking mechanism 807 and key 809 are shown in one location of the latch lock housing 409, it is to be understood that different locking mechanisms are possible and are fully contemplated. One function of the lock 805 is to secure movable part 407 to fixed part 409 of the latch lock housing. Different locks, locking mechanisms, use of keys and keyless locks are possible, known and are contemplated. Typical lock cylinders that may be applied herein are ABLOY CL 290N, or Real Lock RL 1000, or generic T-handle cylinder locks. These lock cylinders may be easily replaced in the field.

If a keyed lock is used, the key entry can be placed almost anywhere on the latch lock housing. In FIG. 8 the key entry is shown on the bottom right of the latch lock housing 409. In one embodiment of the present invention a location of a key entry is on the bottom of the latch lock housing 409. In one embodiment of the present invention a location of a key entry is on the front of the latch lock housing 409.

In one embodiment of the present invention a locking mechanism is part of the movable part 407 of the latch lock. A key entry is then available through the fixed part 409 of the latch lock. Activating a lock with the key in such an embodiment may engage a bolt or a locking element with a capturing part or a hole of the fixed part 409 of the latch lock.

FIG. 8 also illustrates additional details and a shape of the movable part 407 of the latch lock. The movable part has an opening or recess 801 which corresponds to the shape of 501 of the fixed part 409. Both openings 801 and 501 are enabled to receive the handle 108 in a certain position. To facilitate the reception of the handle 108 by the latch lock, the openings 501 and 801 both are preferably slightly larger than the size of the handle part to be received. The movable part 407 of the latch lock has a lock engaging bolt 803 that can be captured by receiving element 806 in lock 805 and has for instance a small recess to receive a securing element of locking mechanism 805 to secure 803 inside the lock 805 and thus secures 407 inside 409. Depending on the size or width of handle 108, movable part 407 has a slot on its right side to accommodate the handle 108 in a horizontal position inside 407 and 409.

Except for the opening 801 the movable part 407 can be of solid material or it can be hollow, except for required slots. One requirement of the shape of 407 is that it can be moved into and slide inside 409. Furthermore, the position of recess 801 in part 407 should be such that after 407 is moved into 409 so that openings 801 and 501 are substantially aligned, the handle is received into 501/801 and the handle is rotated down into side slots 502 and 503 at the same time moving 407 down into 409, that in the locked position handle 108 blocks the side slots 502 and 503. The handle 108 in the locked position is now inside 409 and inaccessible inside the latch lock.

FIG. 9 further illustrates the lock 805 as an illustrative embodiment of a lock that is part of the latch lock. It illustrates a key operated lock with a key 809. As an illustrative embodiment a bolt 901 is shown that is moved into a position 902 in receiving part 806 that receives element 803 of the movable part 407 of the latch lock. The bolt 901 or any other blocking element that is activated by turning the key, moves into a position where it matches and/or engages the recess in 803 and secures it in a locked position. Other lock mechanisms, including a spring driven or rotating element that is rotated by a key into a blocking position and other embodiments are known.

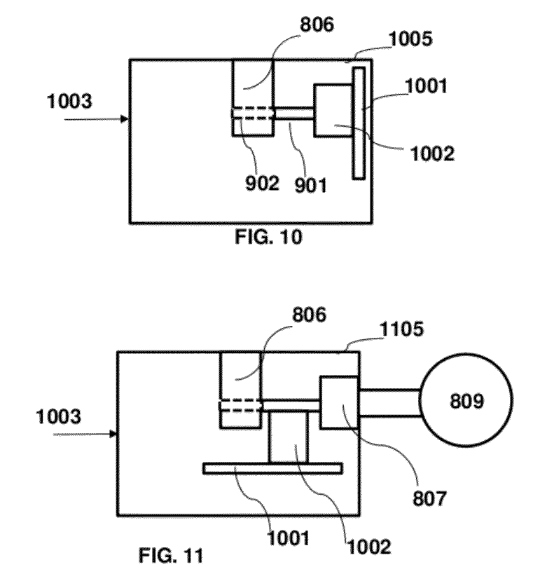

In one embodiment of the present invention, the lock is a remotely activated and de-activated lock. FIG. 10 illustrates the remotely operated lock 1005. It still has the bolt 901 which can be moved in a position 902 in receiving element 806 to capture element 803. However, in this embodiment the bolt is operated by for instance an electromagnetic relay or switch 1002 that when activated places 901 into position 902 and with a following activation puts the bolt 901 back in the unlocked position. The electromagnetic switch 1002 is controlled by a receiver/controller 1001. Receiver/controller 1001 may be a wireless receiver, for instance a Bluetooth device that receives a wireless signal, which contains an opening signal. The receiver/controller 1001 detects the opening signal and provides a control signal to switch 1002 to engage or open bolt 901. Power for the lock may be provided by a local battery or by a source that provides power via a lead 1003. Power may also be provided via 1003 from an external power source. The opening signal is generated by a remote control, such as a cell phone or a dedicated controller that is carried by the driver or any other authorized personnel.

In one embodiment of the present invention, the remote control receives a control signal in a wired fashion, for instance from the cabin of the truck.

In one embodiment of the present invention the lock is a dual custody lock which can be opened by two different keys. Such dual custody locks are well known. One such lock is disclosed in U.S. Pat. No. 474,783 issued on May 10, 1892, which is incorporated herein by reference. In one embodiment of the present invention a first key is a physical key and the second key is an electronic key. The electronic key can be used to locally or remotely lock or unlock the latch lock. Such an embodiment is illustrated in FIG. 11.

A keyed system in one embodiment of the present invention includes a tool operated combination lock RKS (Robotic Key System) as described in U.S. Pat. No. 7,694,542 issued on Apr. 13, 2010 which is incorporated herein by reference.

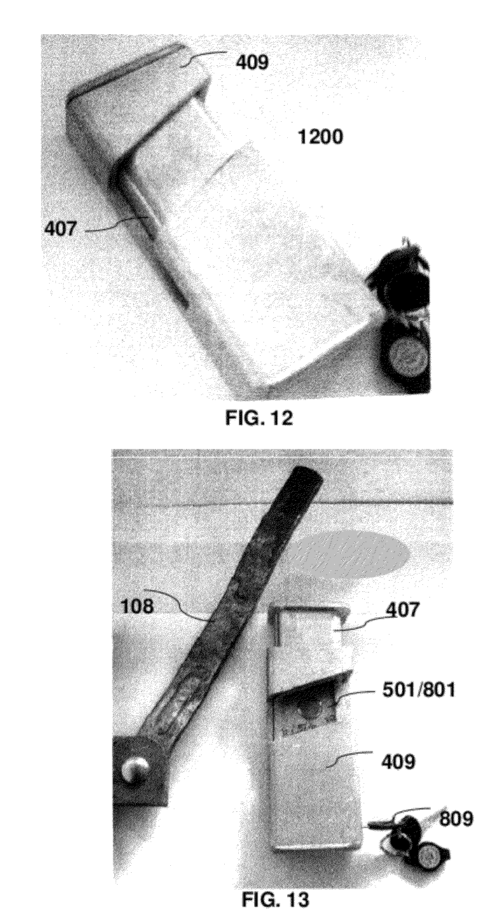

FIG. 12 illustrates the combined latch lock 1200 with the fixed part 409 and the movable part 407 combined in a closed position.

FIG. 13 illustrates the combined latch lock 1200 in accordance with an aspect of the present invention. It shows the handle 108, the fixed part 409 of the latch lock and the movable part 407 of the latch lock. The part 407 has been partially moved in 409 so that their respective openings or recesses (501 and 801 in FIG. 8, now indicated as 501/801) are aligned and ready to receive the handle 108. After lifting 407 inside 409 above the alignment point of 407 and 409 one can let 407 sink by gravity or push 407 lightly down into 409 until the corresponding stops interfere with the movement of the handle. At that time one can insert the handle and push through the flexible or movable stops by moving the handle down and engage the lock 805.

In one embodiment of the present invention the latch lock contains a biasing structure attached to either the movable part or the fixed part of the latch lock that biases the movable part upwards inside the fixed part, such that the openings of the fixed part and the movable part 501/801 are aligned to receive the handle. Such a biasing structure may include a compressible spring for instance around the bolt 803 that biases the two parts and that can be easily compressed to close the latch lock housing.

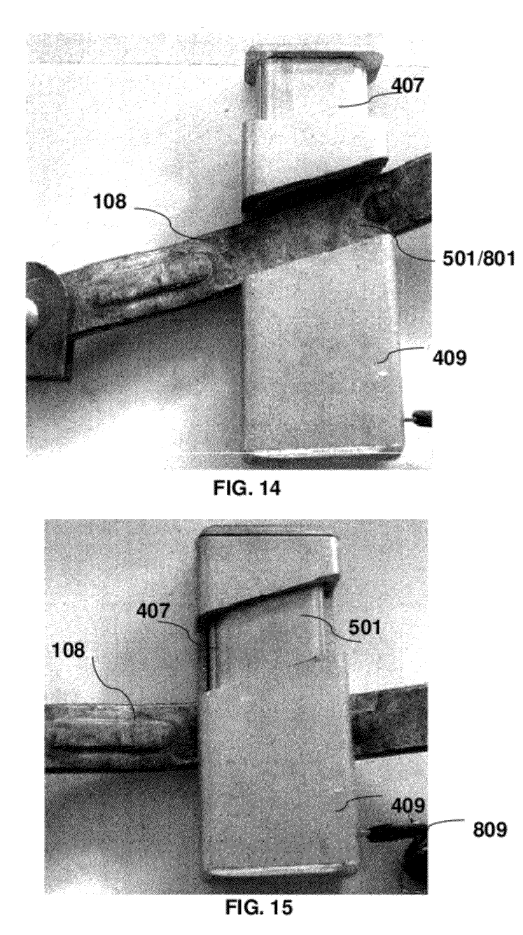

FIG. 14 illustrates the step wherein the handle 108 has been moved into recess 501/801 of the latch lock engaging both fixed 409 and moving 407 elements.

FIG. 15 illustrates the step wherein the handle 108 has been pushed down moving 407 fully into 409 engaging slots 502/503 of 409 to secure the handle 108 by means of lock 805. The opening 501 is now occupied by part of 407. Recess 801 of 407 is now under the cover of 409. The latch lock is now in the closed and secured position.

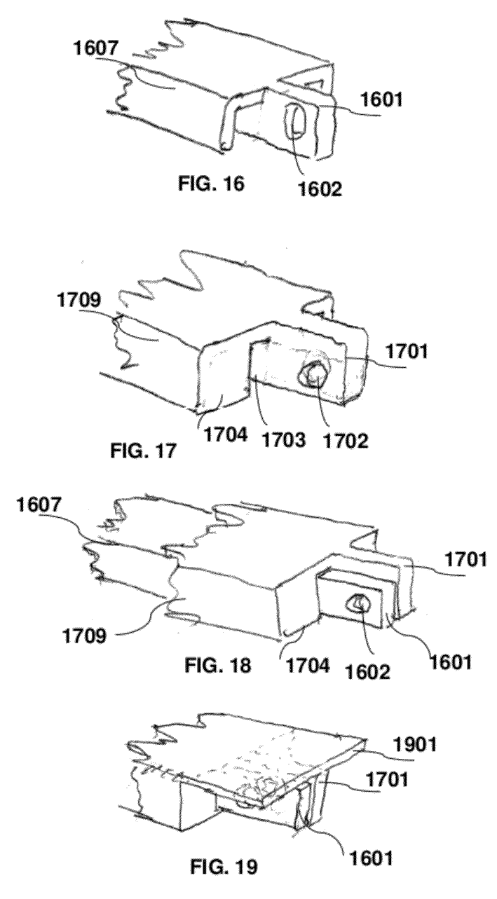

One embodiment in accordance with an aspect of the present invention is illustrated in FIGS. 16-19. In this embodiment a latch lock is provided wherein a separate and non-integrated padlock can be used. The principle of this embodiment is identical to the above configurations related to a fixed and a movable part, the movable part being moved into the fixed part, each having a recess to receive the handle and the embodiment being enabled to lock the handle into a status wherein it is captured in a closed and substantially unmovable position by the latch lock. The embodiment offers locking options.

FIG. 16 illustrates the movable part 1607 corresponding to part 407 of the latch lock with in detail a hasp 1601 at the bottom end of 1607, flange 1601 having a hole 1602 to receive a shackle of a padlock.

FIG. 17 illustrates the fixed part 1709 corresponding to part 409 of the latch lock, which will be fixed against the door. Fixed part 1709 also has a hasp at its bottom. This hasp 1701 is in a different position relative to 1601 of 1607. Hasp 1701 has a hole 1702 to receive the shackle. Next to hasp 1701 is an opening (or an absence of material) that is enabled to receive hasp 1601 when 1607 is moved into 1709. Preferably 1709 has an end wall or stop 1704 that will stop 1607 when moving down into 1709 in such a manner that holes 1602 and 1702 are aligned at the stopping point. This is illustrated in FIG. 18. Movable part 1607 is moved into fixed part 1709 until it hits stop or wall 1704 of 1709. At this point hasps 1601 and 1701 are located next to each other with holes 1602 and 1702 aligned. This enables a shackle to be placed through the holes to lock the closed latch lock.

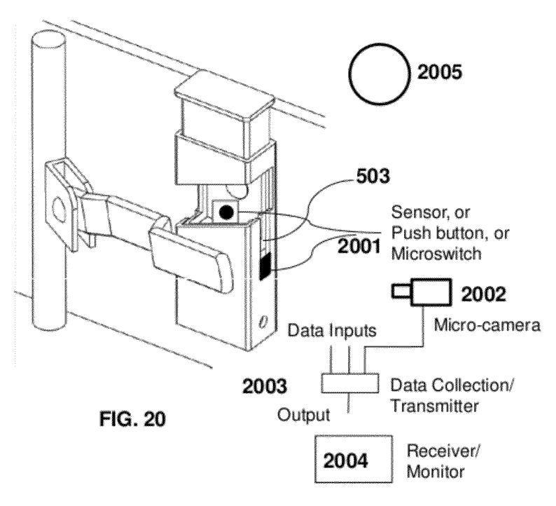

FIG. 19 shows a further embodiment of the embodiment of FIG. 18. The embodiment of FIG. 19 has a shield 1901 as part of the fixed part 1709 which covers substantially the hasps 1601 and 1701 and the shackle of the padlock from a forcing attack.

FIG. 20 illustrates additional features that are provided in accordance with various aspects of the present invention. Positions in the latch lock where the handle touches the latch lock or where the movable and fixed parts of the latch lock touch in a closed position are provided with sensors or push buttons or micro-switches 2001 which are connected to inputs of a data transmitter 2003. Additionally one can use a keyed lock to lock for instance the movable part of the lock that enables a signal that indicates if the lock is open or locked and if a key is in the lock mechanism.

The sensors can be wireless sensors or they can have a wired output. The sensors, if they require a power source can be provided with their own small power source, such as a battery, or they can be powered from an external source.

In a further embodiment, a data collection/transmitter system is attached near the lock to collect data from sensors, switches and camera and may be integrated with a wireless transmitter, as known in the art, to transmit data to a receiver, for instance with a display that is viewable by a driver on a display. The data generated may provide an audit trail.

The data is provided on an output and transmitted either wirelessly or wired to a receiver with a monitor 2004. The receiver may be on the truck. The receiver may also be remotely located from the truck, for instance in a monitoring center. To protect the circuitry, it may be enclosed inside the lock or positioned inside the door or behind the door to which the lock is attached.

The back of the truck may also be provided with one or more cameras such as a micro-camera 2002. A camera may be positioned to provide a view of the lock. A camera may also be position to view a person who approaches the rear of the truck.

A change in a status of a micro-switch may generate a visible or audible alert in the cabin of the truck or on a monitor. The monitor 2004 in one embodiment of the present invention is a portable monitor such as a cell phone or a portable computing device. This allows an operator of a truck, who is away from the truck, for instance to make a delivery, to view activity related to the lock. In one embodiment of the present invention the receiver 2004 is also enabled to transmit and for instance to activate an alarm such as an audible alarm device 2005 on the truck.

Monitoring of a state of the lock.

In accordance with an aspect of the present invention the state of the lock, which may be one of:

a) lock is unlocked, lever is outside lock;
b) lever is inside slot of lock, movable part of lock is in open position;
c) lever is inside slot of lock, movable part of lock is in closed position, keyed lock is unlocked;
d) lever is inside slot of lock, movable part of lock is in closed position, keyed lock is locked;
e) lever is outside slot of lock; and
f) or any other possible configuration of lever position, keyed lock status, the lock's movable part status, or the status of any other part relevant to the status of the lock.

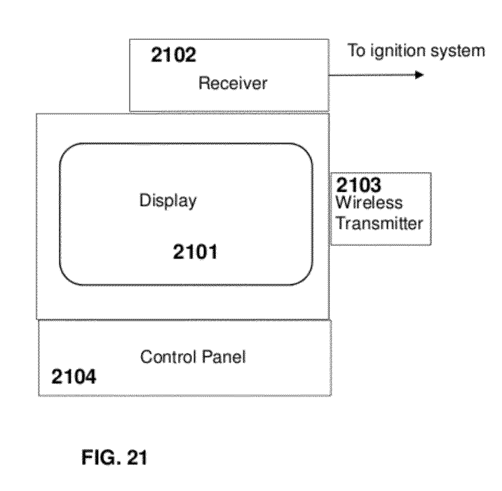

FIG. 21 illustrates a display 2101 in accordance with an aspect of the present invention. It has a receiver 2102 to receive signals generated by the transmitter that transmits sensor data related to the lock possibly as a modulated signal and demodulates the signal if required and presents data recovered from the received signal in a displayable form to a display 2101. Many trucks already have a display, either as part of an on-board computer system or as part of an on-board navigation system. A control panel 2104 allows an operator to view lock related data or images, if so desired. The system can be configured in such a way that the system provides an alert, for instance on the display, or through a sound signal, if the driver drives the truck away without locking the lock.

In yet a further embodiment of the present invention, one or more signals, provided to the display may be re-transmitted through a wireless transmitter 2103 to a wireless network or to a wireless mobile device. This allows the lock to be monitored remotely, for instance when the driver goes into a building for a delivery.

It is anticipated that the invention could include additional electronics to monitor the activity of the latch mechanism to provide an audit trail and/or allow integration into and/or communication with other security systems on or off the vehicle.

In a further embodiment of the present invention the locking mechanism retains the key until the mechanism is latched to prevent the driver from starting the vehicle when the latch is not secured.

In a further embodiment of the present invention an electronic circuit can disable the ignition system of the vehicle and/or sound an alarm if the latch is unsecured. For instance the receiver in the truck has a circuit that monitors if the movable part of the lock is closed and the latch lever is inside the lock slot and the keyed lock is locked. If that is the case an output to the ignition system provides a signal that enables the ignition.

It is also anticipated that the members of the mechanism include features to accept tamper indicative seals and/or devices. For instance, the lock may be provided with small holes that allow the threading of a tamper seal, such as PRIVASEAL® brand protective seals have long been used as one time use security elements to provide evidence of tampering or access to secured objects. PRIVASEAL is a registered trademark of Stanton Concepts, Inc., P.O. Box 139, Stanton, N.J. Locks incorporating seals as part of the security function in combination with key or keyless (combination) mechanisms are known. The seals are typically incorporated into the conventional locks such that the integrity of the seal is compromised upon opening or attempted opening of the lock to indicate access or tampering. Preferably, the seal is arranged such that tampering is readily apparent upon initial visual observation.

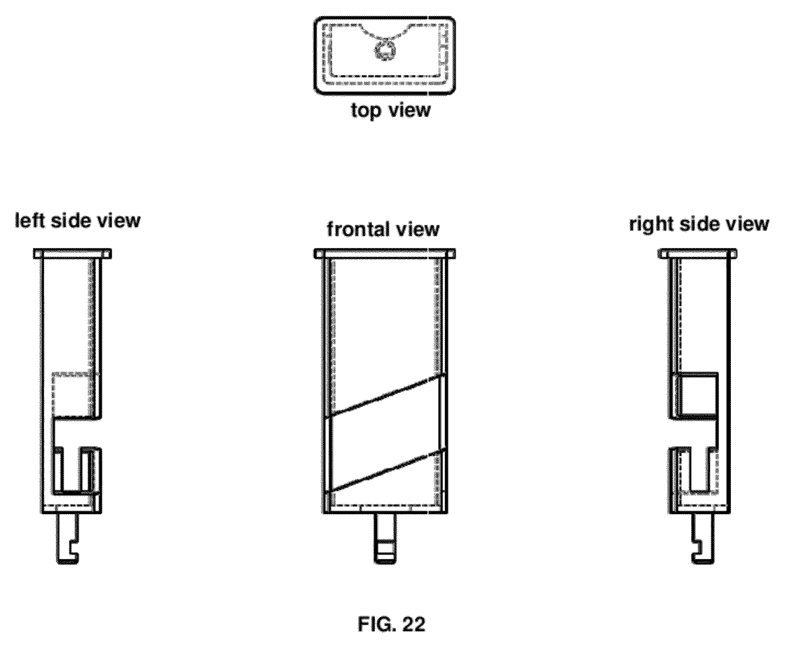

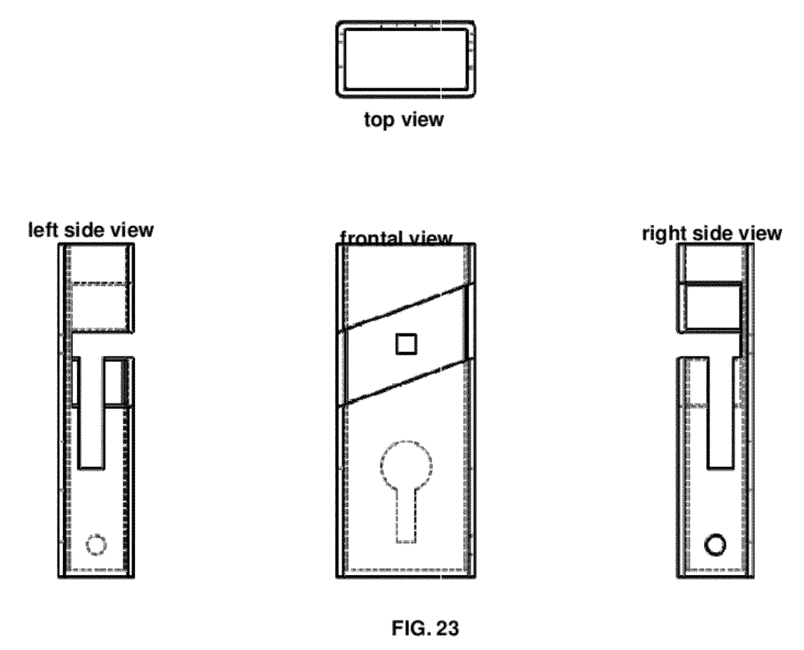

FIG. 22 provides different views of an embodiment of the movable part of the latch lock. FIG. 23 provides different views of an embodiment of the fixed part or housing of the latch lock.

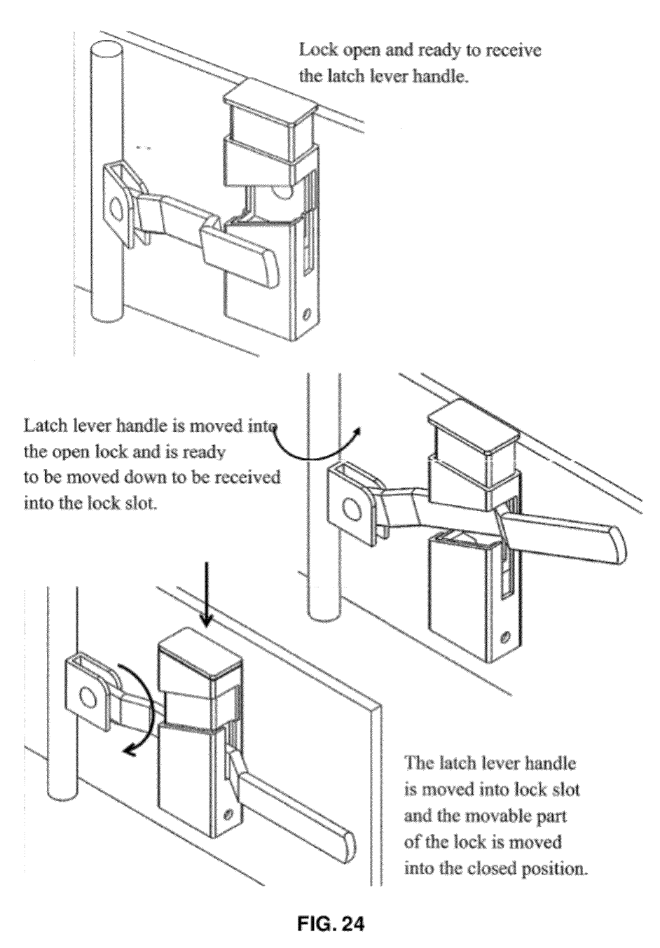

FIG. 24 illustrates a method of locking a handle of vertical rod engaging latch lock in accordance with various aspects of the present invention.

In one embodiment of the present invention, the latch lock as provided herein in accordance with one or more aspects of the present invention is applied on a door of a truck. In one embodiment of the present invention the latch lock as provided herein in accordance with one or more aspects of the present invention is applied on a door of a truck, a trailer or a shipping container. In one embodiment of the present invention the latch lock as provided herein in accordance with one or more aspects of the present invention is applied on a door of a container. In one embodiment of the present invention the latch lock as provided herein in accordance with one or more aspects of the present invention is applied on any door that is secured to a frame by means of vertical rod engagement as for example to the side doors found on trucks used for urban deliveries.

The above provides a latch lock and operation thereof in accordance with various aspects of the present invention. While the closing and locking of a novel latch lock in accordance with various aspects of the present invention have been described above, it is to be understood that the described steps executed in reverse order fully disclose the unlocking and/or opening of the novel latch lock in accordance with one or more steps of the present invention.

A number of embodiments of the invention have been described. Nevertheless, it will be understood that various modifications may be made without departing from the spirit and scope of the invention. Accordingly, other embodiments are within the scope of the following claims.

1. A lock to secure a handle, the handle having a width and a thickness, comprising:
a housing that is at least partially hollowed with a top opening to receive a movable part that fits inside the housing, the housing including an angled opening across a front face enabled to receive the width of the handle in a first position, the housing including a first slot in a first side of the housing below the angled opening and a second slot in a second side of the housing below the angled opening, the first slot and the second slot enabled to receive the thickness of the handle;
the movable part including an angled opening across a front face enabled to receive the width of the handle in the first position when the movable part is inside the housing and the angled openings of the housing and the movable part are aligned, and wherein
the housing covers at least partially the angled opening of the movable part and the movable part fills at least partially the angled opening of the housing when the handle is moved from the first position into a second position.

2. The lock of claim 1, further comprising a locking mechanism that secures the movable part to the housing.

3. The lock of claim 1, wherein the housing is secured to a door.

4. The lock of claim 3, wherein the door is on a truck and the handle is part of a vertical rod engaging lock.

5. The lock of claim 2, wherein the locking mechanism is a keyless lock.

6. The lock of claim 2, wherein the locking mechanism is an electronic lock.

7. The lock of claim 2, wherein the locking mechanism is a dual custody lock.

8. The lock of claim 2, further comprising a mobile computing device connected to the lock to monitor a status of the lock.

9. The lock of claim 1, wherein the lock replaces an existing lock.

10. The lock of claim 1, further comprising a camera monitoring the lock to record an event related to the lock.

11. A method of securing a door to a frame, comprising:
aligning an opening in a fixed latch lock element with an opening in a moving latch lock element located in the latch lock;
placing a handle inside the aligned openings in the fixed and moving latch lock elements; and
moving the handle inside the latch lock to a blocked position, wherein the moving element moves downward in the latch lock and moves through a slot in a side of the latch lock,
wherein the handle is locked in place by the latch lock.

12. The method of claim 11, further comprising locking the moving part to the latch lock with a lock.

13. The method of claim 12, wherein the lock is a keyless lock.

14. The method of claim 12, wherein the lock is a remotely controlled lock.

15. The method of claim 12, wherein the lock is a Robotic Key System (RKS).

16. The method of claim 12, wherein the lock is a dual custody lock.

17. The method of claim 11, wherein the door is on a truck and the handle is part of a vertical rod engaging lock.

18. The method of claim 11, wherein the door is on a trailer.

19. The method of claim 11, wherein the door is on a shipping container.

20. The method of claim 11, further comprising monitoring a status of the door with a sensor.
